(19) United States
(12) Patent Application Publication
(10) Pub. No.: US 2026/0212562 A1
(43) Pub. Date: Jul. 23, 2026

(54) PHOTO ALBUM IMAGE TAGGING METHOD

(71) Applicant: MemoriesNet Technology Limited, HONG KONG (CN)

(72) Inventor: Peijian XU, Guangzhou (CN)

(21) Appl. No.: 19/385,119

(22) Filed: Nov. 10, 2025

(30) Foreign Application Priority Data
Jan. 20, 2025 (CN) 202510089291.4

(51) Int. Cl. G06T 11/60

(52) U.S. Cl. CPC G06T 11/60; G06T 2200/24

(57) ABSTRACT

A photo album image tagging method for improving image management efficiency and browsing experience. The method enables a user to select one or more unit images in different window interfaces of a photo album and trigger the display of a text view window through a specific interactive action. In the text view window, the user may input custom text content regarding tags, main groups, and sub-groups, which is converted into corresponding unit tag information, group tag information, and sub-tag information displayed on unit tag overlay layers, group tag overlay layers, and sub-tag overlay layers superimposed on the selected unit images, main album sets, and sub-album sets. Through a single interactive module, the user can intuitively and efficiently locate desired images, thereby significantly enhancing image management efficiency.

### TECHNICAL FIELD

The disclosure described herein relates to the technical field of image processing and information management, and more particularly to a photo album image tagging method.

### BACKGROUND

With the rapid advancement of digital technology, images have become an indispensable medium of information in daily life and work. With the widespread use of digital cameras, smartphones, and other devices, as well as the popularity of social media and cloud storage services, the number of images captured and stored by users is increasing exponentially. This explosive growth poses a significant challenge: how to efficiently manage and retrieve massive image resources.

Existing photo album image management and tagging methods suffer from the following problems:

Complexity of text input in traditional tagging methods: Traditional tagging methods usually require five to ten cumbersome steps to complete text input. These steps may include opening the tagging tool, selecting a text input box, positioning the input cursor, entering text content, and adjusting text formatting, making the process lengthy and complicated.

Difficulty in setting traditional tag text styles: When setting parameters such as text size, font color, and placement position of traditional tag text, users typically need to perform four to six steps. These may involve selecting a style menu, adjusting parameter values, and previewing the result, thereby increasing operational complexity and time costs.

Editing limitations of traditional tag text: Traditional text tagging methods have two major limitations. One approach directly modifies the original photo, which is typically irreversible—once tagging is completed, the user cannot undo the prior operation. The other approach allows undoing to restore the original state, but the text cannot be re-edited afterward, restricting user flexibility and creativity.

Issues with saving and editing traditional tag text: Traditional tag text can be saved as a new photo containing the added tags; however, this saving method directly overwrites the original photo, thereby also inheriting the same problems of irreversibility and lack of editability. This means that once the tagged photo is saved, the user cannot make any form of modification or revocation to the tag content.

Limitations in searching traditional tag text: When performing searches involving traditional tag text, the search generally relies on optical character recognition (OCR) technology. However, such technology often exhibits a high recognition error rate and may retrieve irrelevant information along with the intended data, resulting in low matching accuracy and failing to meet users’ needs for precise searches.

Cumbersome operations in traditional album structures: Traditional photo album structures typically adopt a hierarchical or tree-based structure, requiring users to repeatedly enter and return to the home page when viewing different albums. This operation is cumbersome and significantly degrades the user experience.

Photo management issues in traditional albums: Traditional albums often lack a sub-album structure, making it time-consuming and labor-intensive to browse when the number of photos increases. Even when a sub-album feature exists, users still need to perform additional hierarchical entry and exit operations, which further increases operational complexity.

Limitations on cross-album operations: The structure of traditional albums restricts users from selecting and performing batch operations across photos from different albums. Such limitations cause considerable inconvenience when managing a large number of photos.

Separation between album creation and tagging operations: In traditional systems, album creation and tagging are handled through separate operation modules, preventing both processes from being conducted simultaneously. This separation design increases the number of user actions required and adds to the overall time cost.

Cumbersome process for adding sub-albums in traditional albums: In traditional albums, adding a sub-album requires additional operation steps. After creating a sub-album, users must manually add photos to it one by one. This cumbersome operation flow reduces the efficiency of photo management.

### SUMMARY

The disclosure described herein is intended to address the problems of cumbersome operations, high user learning costs, and difficulties in photo retrieval in existing photo album management systems, and provides an innovative photo album image tagging and classification method. Through a series of predetermined and concise interactive actions, users can, with minimal operational steps, perform batch tagging of one or more photos, including preset positioning and text style configurations. The user’s information input directly reflects their operational logic and intent, thereby significantly reducing the learning cost and improving the user experience.

To achieve the foregoing objectives, the photo album image tagging method provided by the disclosure described herein includes the steps of:

selecting at least one unit image in a thumbnail window of the album, or selecting a single unit image displayed in a detailed viewing window of the album;

receiving an addition instruction to add tag information to the selected unit image;

displaying a text view window for inputting text content;

receiving, in the text view window, at least one item of text content relating to a tag; and

converting the text content of the tag into corresponding unit tag information, and causing the unit tag information to float and display on a unit tag overlay layer superimposed over the selected unit image.

Furthermore, the method further comprises:

receiving, within the text viewing window, at least one item of text content related to a main group; and

based on the text content of the main group, grouping and folding the selected unit images to form an orderly arranged main album set, and converting the text content of the main group into corresponding group tag information, such that the group tag information floats and displays on the group tag overlay layer superimposed over the collected main album set and/or on the unit tag overlay layer superimposed over the selected unit images.

Furthermore, the method further comprises:

receiving, within the text viewing window, text content related to the main group and subgroup; and

based on the text content of the subgroup, grouping and collecting the selected unit images to form an orderly arranged sub-album set, and based on the text content of the main group, forming the sub-album set into a new main album set or incorporating it into an existing main album set, such that the text content of the subgroup is converted into sub-tag information that floats and displays on the sub-tag overlay layer superimposed over the collected sub-album set and/or on the unit tag overlay layer superimposed over the selected unit images, and the text content of the main group is converted into group tag information that floats and displays on the sub-tag overlay layer superimposed over the collected sub-album set.

Furthermore, when at least one unit image in the thumbnail window of the album is selected, the adding instruction is a predetermined interactive action, such that the text viewing window is displayed based on the interactive action.

Furthermore, when a single unit image displayed in the detailed viewing window of the album is selected, the adding instruction is a selected add menu item within the detailed viewing window, such that the text viewing window is displayed based on the selection of the add menu item.

Furthermore, the text viewing window is provided with at least one tag text box for inputting text content related to a tag.

Furthermore, the text viewing window is provided with at least one tag text box for inputting text content related to a main group and a subgroup.

The disclosure described herein provides the following advantageous effects:

It offers an efficient and intuitive image tagging method, enabling users to add customized tags to images through simple interactive actions.

By implementing hierarchical management through main group and subgroup tagging, the disclosure enhances image categorization and retrieval efficiency.

3) The user interface is simple and clear, easy to operate, and improves overall user experience.

### BRIEF DESCRIPTION OF THE DRAWINGS

FIG. 1 is a schematic flow diagram illustrating steps S101–S105 of the album image tagging method;

FIG. 2 is a schematic flow diagram illustrating steps S201–S202 of the album image tagging method;

FIG. 3 is a schematic flow diagram illustrating steps S301–S302 of the album image tagging method;

FIG. 4 is a schematic diagram showing at least one unit image selected in the thumbnail window of the album;

FIG. 5 is a schematic diagram showing a single unit image selected in the detailed viewing window of the album;

FIG. 6 is a schematic diagram showing the layer stacking of the text viewing window in the thumbnail window of the album;

FIG. 7 is a schematic diagram showing the layer stacking of the text viewing window in the detailed viewing window of the album; and

FIGS. 8-10 are schematic diagrams showing the layer stacking of the tag overlay layers in the thumbnail window of the album.

### DETAILED DESCRIPTION

For a better understanding of the disclosure discussed herein, the following provides a more comprehensive description of the disclosure with reference to the accompanying drawings. The preferred embodiments of the disclosure discussed herein are illustrated in the drawings. However, it should be understood that the disclosure discussed herein may be embodied in many different forms and should not be construed as limited to the embodiments set forth herein. The embodiments are provided so that the disclosure discussed herein may be thorough and complete.

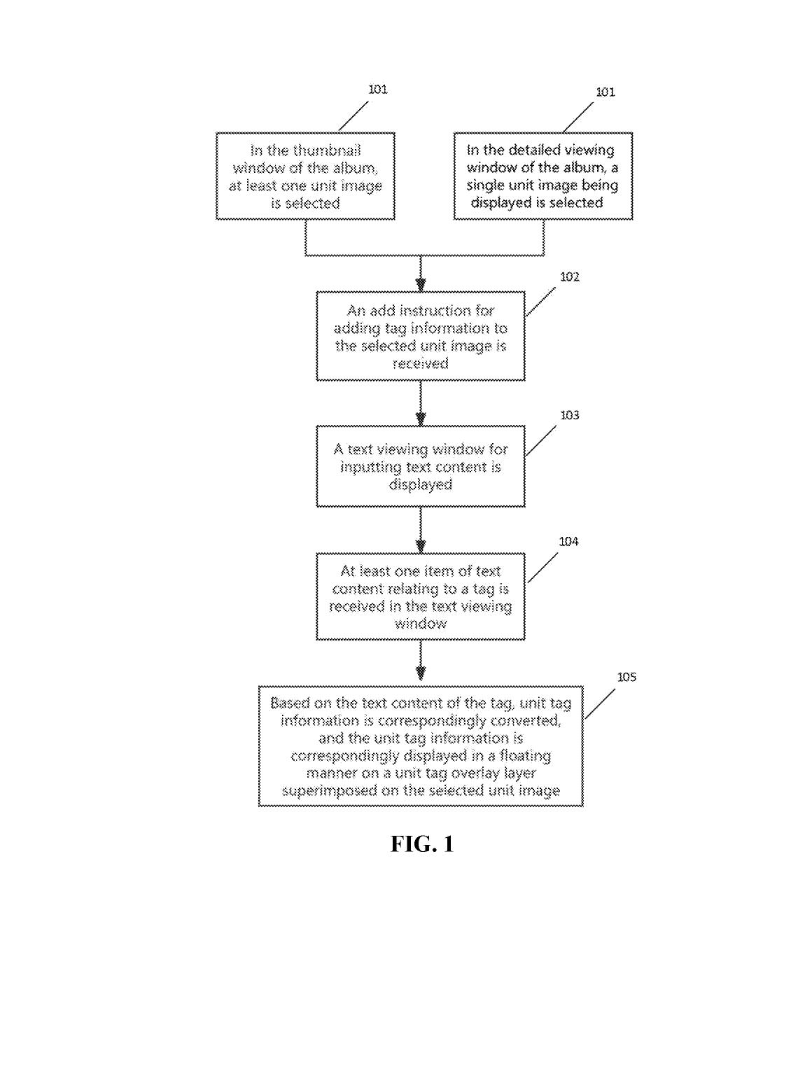

As shown in FIGS. 1-10, in the disclosure embodiment, a photo album image tagging method is disclosed. The tagging method is applicable to an electronic device, wherein the electronic device may include, but is not limited to, a smartphone, a tablet computer, a smart television, an electronic book reader, a laptop computer, or a desktop computer. As shown in FIG. 1, the photo album image tagging method comprises the following steps.

In step S101, at least one unit image is selected in a thumbnail window of the photo album, or a single unit image displayed in a detailed viewing window of the photo album is selected. The thumbnail window of the photo album displays a plurality of unit images in a reduced and tiled arrangement, whereas the detailed viewing window displays a single unit image in an enlarged manner. At this stage, the user may select one or more unit images in different album window interfaces through specific operational actions, such as single-clicking, sliding selection, box selection, or individual selection across different albums.

In step S102, an addition instruction for adding tag information to the selected unit image is received. The addition instruction varies depending on the user’s operation in different album window interfaces. Specifically, when at least one unit image is selected in the thumbnail window of the album, the addition instruction is a predetermined interactive action (such as a double-click or long press), whereby a text view window is displayed based on the interactive action. When a single unit image displayed in the detailed viewing window of the album is selected, the addition instruction is that the “Add” menu item in the detailed viewing window is selected, whereby a text view window is displayed based on the selection of the “Add” menu item.

In step S103, a text view window for inputting text content is displayed, wherein the text view window is provided with at least one tag text box capable of receiving text content corresponding to a tag. At this point, the user may freely input customized text content regarding the tag in the tag text box.

In step S104, at least one piece of text content corresponding to the tag, which is input in the text view window, is received. That is, after the user has completed customized input of text content regarding the tag in the tag text box, the user may press the “Enter” key provided on the input keyboard of the electronic device to complete the text input for that tag text box. The user may then terminate the text input or proceed to the next tag text box to continue inputting text content.

In step S105, the text content of the tag is correspondingly converted into unit tag information, and the unit tag information is superimposed and displayed on a unit tag overlay layer overlaid on the selected unit image.

Reference is made to the linkage relationship between different album windows and tag overlay layers, which has been described in the applicant’s other related applications. For ease of understanding, the tag overlay layer is briefly described as follows. A tag overlay layer is superimposed over the thumbnail window or the detailed viewing window of the album. The tag overlay layer is formed in correspondence with the layout of the thumbnail window, thereby forming a unit tag overlay layer overlapping each unit image. Accordingly, the unit tag information is displayed in a floating manner on the unit tag overlay layer overlapping the unit image. Furthermore, under the detailed viewing window of the album, the user may select a desired display mode for the unit tag information as needed, such as stacked display, exit, or hide. Under the thumbnail window of the album, however, the unit tag information remains displayed persistently. In this way, visual interference that may occur during the user’s detailed viewing of a single unit image can be avoided, thereby preventing disruption of the user’s detailed browsing experience.

The foregoing embodiments describe, under different album windows, the editing and display of unit tag information for one or more unit images. The user may complete the tagging of unit images within a single text view window, thereby greatly reducing the difficulty of use and enabling simple and efficient operation.

For ease of understanding, the following provides further explanation and illustration with reference to specific figures and example cases.

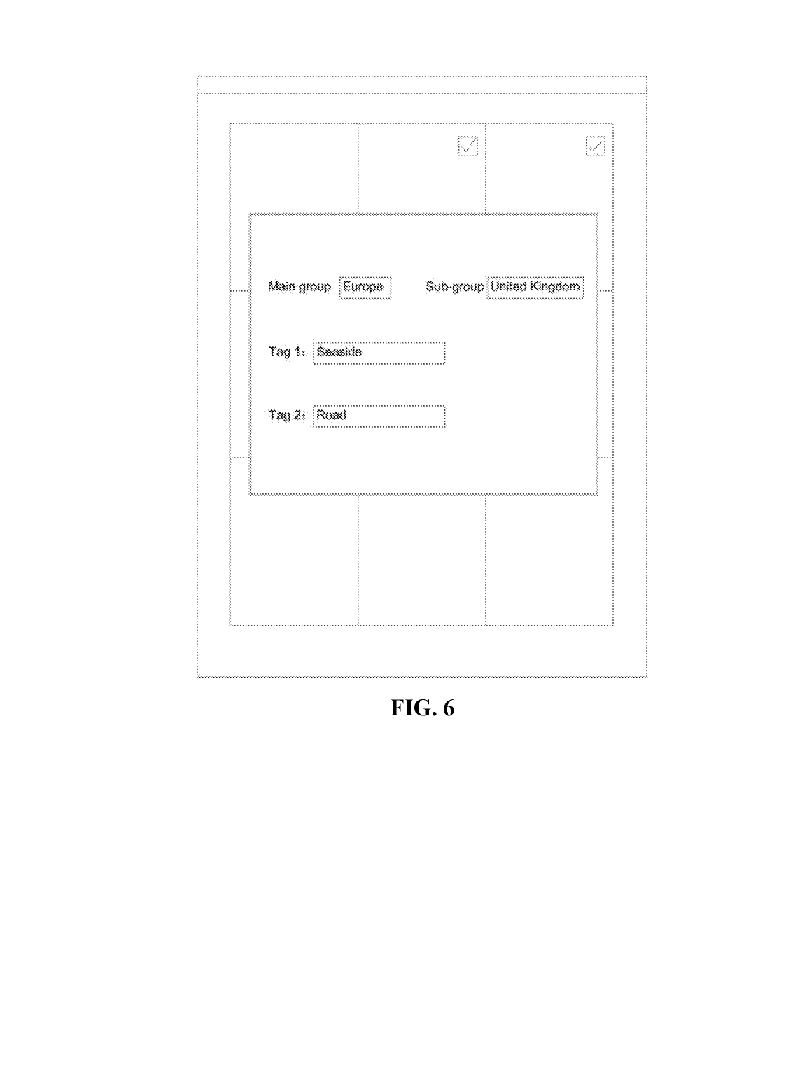

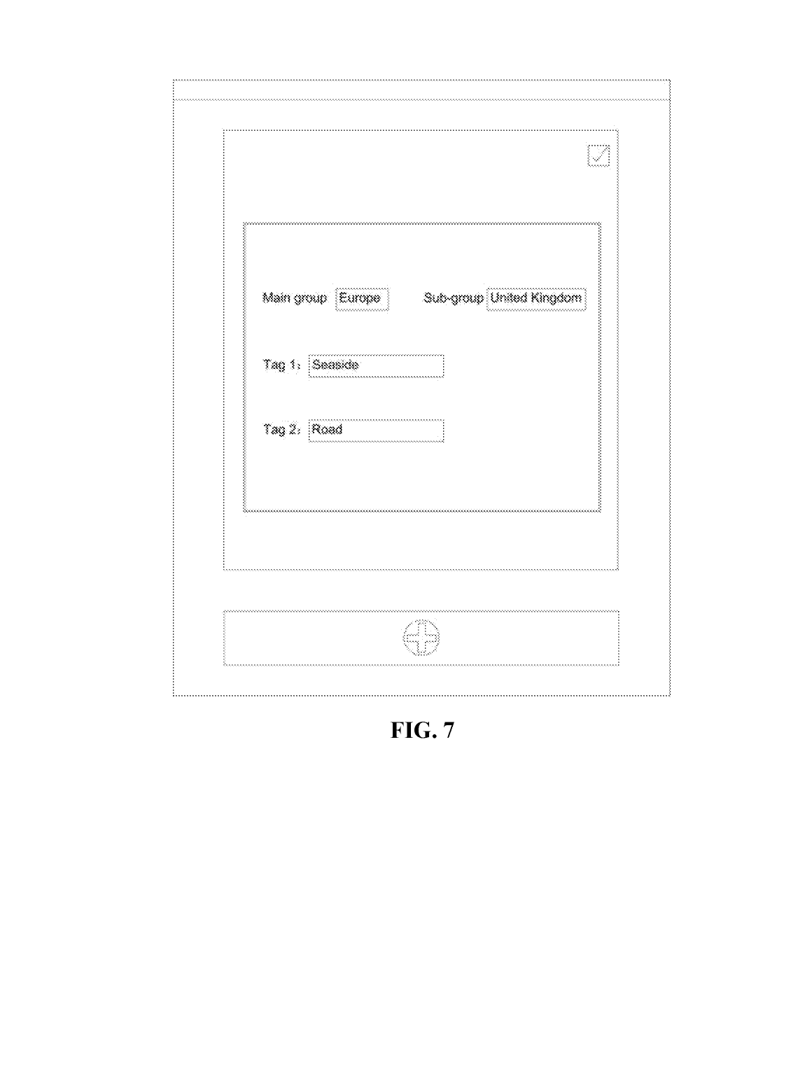

FIG. 4 illustrates, according to an exemplary embodiment, that at least one unit image is selected in the thumbnail window of the album. At this time, the user may, as needed, select one or more unit images in the thumbnail window of the album, and subsequently trigger the display of the text view window through a predetermined interactive action. FIG. 5 illustrates, according to an exemplary embodiment, that a single unit image displayed in the detailed viewing window of the album is selected. At this time, the user selects the current unit image in the detailed viewing window and selects the “Add” menu item in the menu of the detailed viewing window (preferably, the menu may be located at the bottom or another position of the detailed viewing window; during the viewing of a unit image, the menu is hidden and can be called out through a specific interactive operation or a designated button). The selection of the “Add” menu item thereby triggers the display of the text view window.

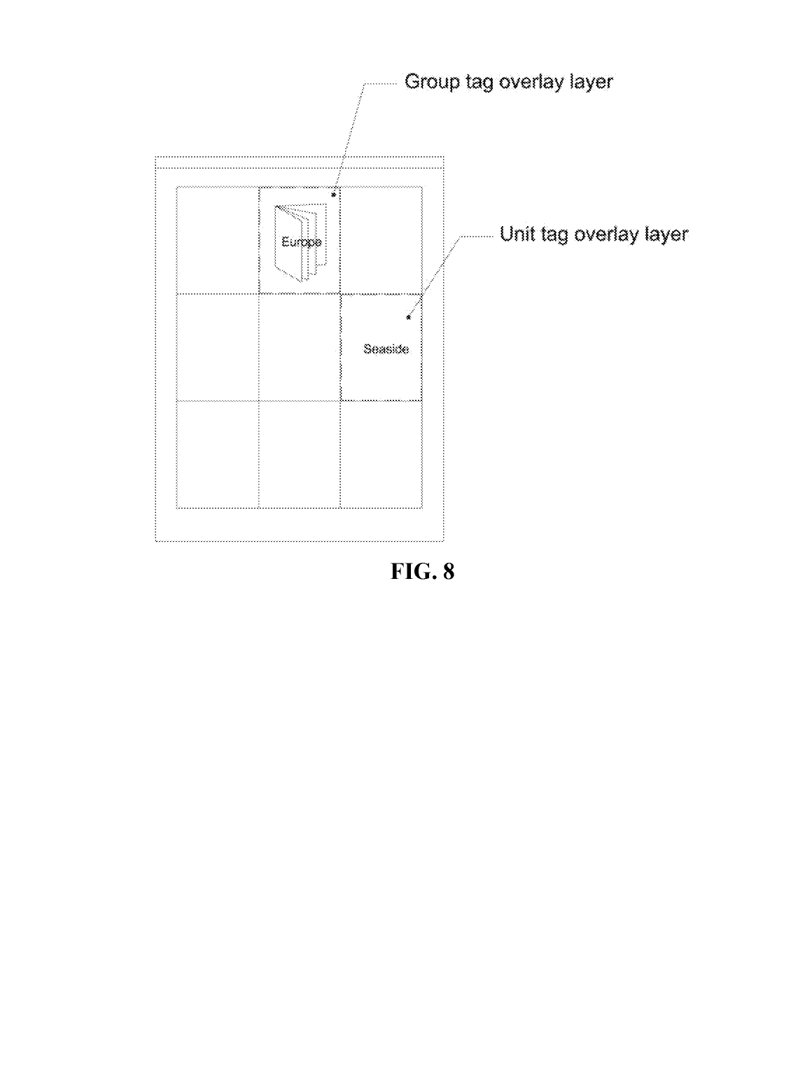

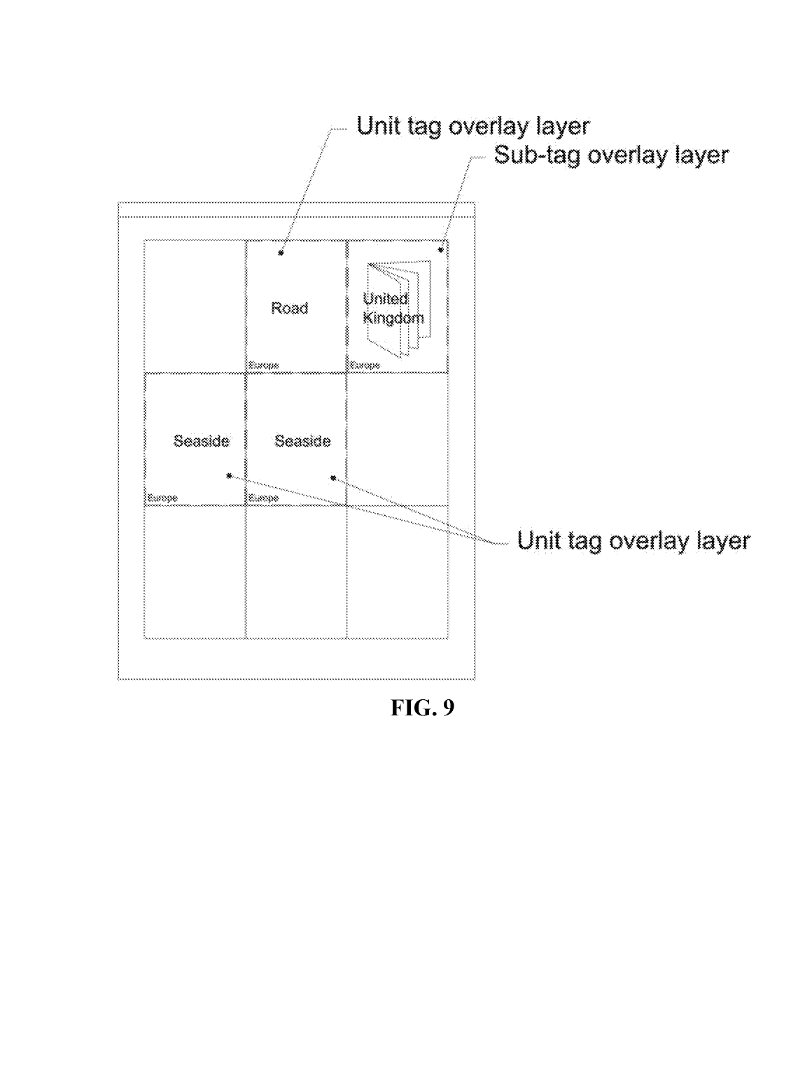

FIGS. 6 and 7 illustrate, according to an exemplary embodiment, the text view window. At this time, the user inputs the text content “seaside” in one of the tag text boxes of the text view window, to be used as subsequent unit tag information. In addition, the user may input the text content “road” in another tag text box of the text view window as required, to be used as subsequent unit tag information.

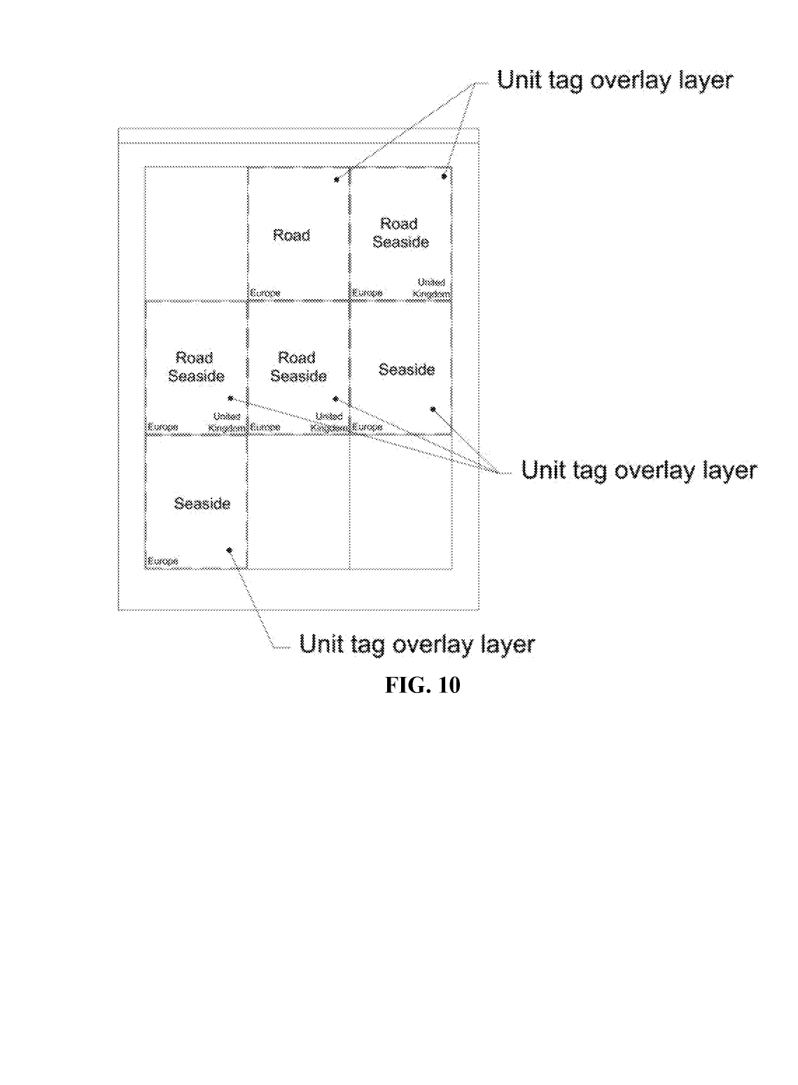

FIGS. 8-10 illustrate, according to an exemplary embodiment, the text view window. Based on the received text content “seaside” and/or “road,” the system converts the text content into unit tag information. The unit tag information, compared with the original text content, possesses specific formatting parameters such as font style, color, and font size (the formatting parameters may be adjusted according to user preferences or system default settings to ensure clear readability of the unit tag information). As a result, the unit tag information is displayed in a floating manner on the unit tag overlay layer overlapping the corresponding unit image.

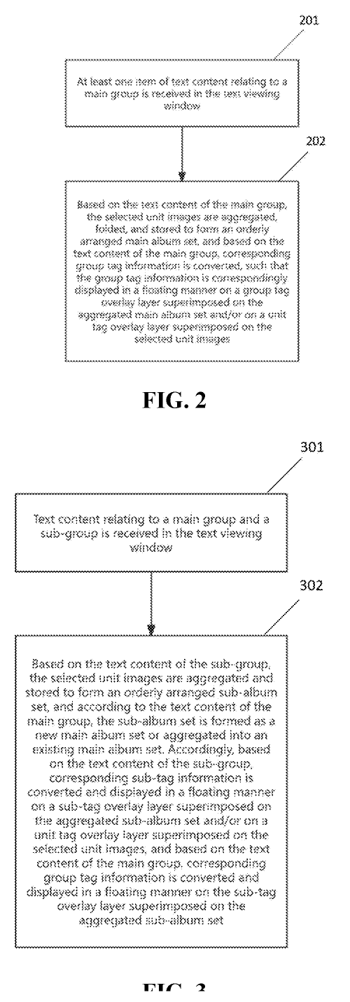

In the disclosure embodiment, as shown in FIG. 2, the photo album image tagging method further comprises the following steps.

In step S201, at least one piece of text content regarding a main group is received in the text view window, wherein the text view window is provided with at least one tag text box for inputting text content regarding the main group. At this time, the user may freely input customized text content regarding the main group in the tag text box.

In step S202, based on the text content of the main group, the selected unit images are collected, folded, and stored to form an orderly arranged main album set. The text content of the main group is correspondingly converted into group tag information, such that the group tag information is displayed in a floating manner on a group tag overlay layer superimposed on the collected main album set and/or on a unit tag overlay layer superimposed on the selected unit image.

Specifically, each selected unit image is folded and stored to form the main album set. A tag overlay layer superimposed over the thumbnail window corresponds to the overlapping region of the main album set, forming an overlapping and associated group tag overlay layer. The text content input by the user regarding the main group is converted into group tag information, which is displayed in a floating manner within the group tag overlay layer. Likewise, the group tag information may also be displayed in a floating manner on the unit tag overlay layer superimposed on the unit image, thereby allowing the user to more intuitively and rapidly identify the corresponding main album set and to visually recognize the main album set to which each unit image belongs.

In summary, steps S201–S202 serve as an extended process of steps S101–S105, for handling text content associated with the main group.

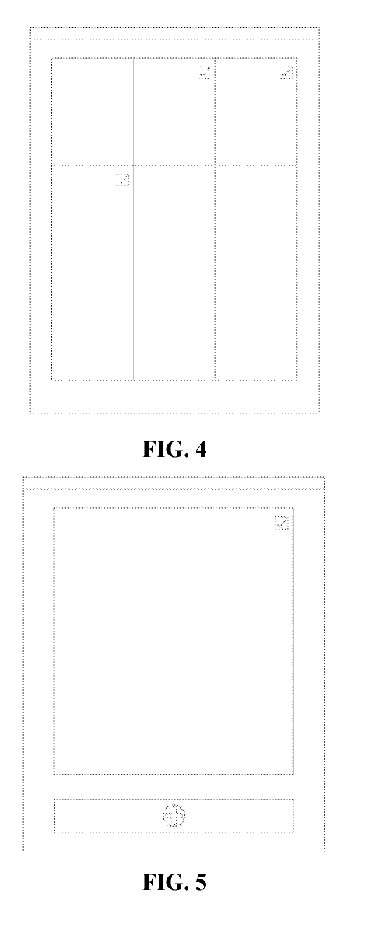

In the disclosure embodiment, as shown in FIG. 3, the photo album image tagging method further comprises the following step.

In step S301, text content regarding both a main group and a sub-group is received in the text view window, wherein the text view window is provided with at least one tag text box for inputting text content regarding the main group and the sub-group. At this time, the user may freely input customized text content regarding the main group and the sub-group in the tag text box.

In step S302, based on the text content of a sub-group, the selected unit images are collected and stored to form an orderly arranged sub-album set. The sub-album set is then either formed as a new main album set or collected into an existing main album set according to the text content of the main group. Accordingly, the text content of the sub-group is converted into sub-tag information, which is displayed in a floating manner on a sub-tag overlay layer superimposed on the collected sub-album set and/or on a unit tag overlay layer superimposed on the selected unit image. Furthermore, the text content of the main group is correspondingly converted into group tag information, which is displayed in a floating manner on the sub-tag overlay layer superimposed on the collected sub-album set.

Specifically, after several unit images are collected to form an image group, further classification and grouping of the individual unit images within the same image group may be carried out as required. Thus, the user may select one or more unit images within the same main album set and collect them as a new sub-group. Accordingly, the unit images of the new sub-group are folded and stored in the expanded interface of the main album set to form an orderly arranged sub-album set. The tag overlay layer, based on the image layout of the thumbnail window, then forms a one-to-one corresponding and overlapping sub-tag overlay layer in the overlapping region of the sub-album set. Based thereon, the text content of the sub-group is converted into sub-tag information, which is displayed in a floating manner on the sub-tag overlay layer superimposed on the collected sub-album set. Likewise, the sub-tag information may also be displayed in a floating manner on the unit tag overlay layer superimposed on the unit images within the same sub-album set. In addition, the text content of the main group is correspondingly converted into group tag information, which is displayed in a floating manner on the sub-tag overlay layer superimposed on the collected sub-album set. In this manner, the user can more intuitively and quickly locate the corresponding main album set and sub-album set and visually recognize the main album set to which each unit image and sub-album set belong.

In summary, steps S301–S302 serve as a further process extension of steps S201–S202, for handling text content associated with both main groups and sub-groups.

Furthermore, the sub-tag information and group tag information, compared with the text content of the main group and sub-group, possess specific formatting parameters such as font style, color, and font size (the formatting parameters may be adjusted according to user preferences or system default settings to ensure clear readability of the sub-tag information and group tag information). Accordingly, the sub-tag information and group tag information are displayed clearly and intelligibly in a floating manner on the group tag overlay layer, the sub-tag overlay layer, and the unit tag overlay layer.

For ease of understanding, the following provides further explanation and illustration with reference to specific figures and example cases.

FIGS. 6 and 7 illustrate, according to an exemplary embodiment, the text view window, wherein the received text content “Europe” is converted into group tag information, such that the group tag information is displayed in a floating manner on the group tag overlay layer superimposed on the main album set and/or on the unit tag overlay layer superimposed on the selected unit image.

FIGS. 8-10 illustrate, according to an exemplary embodiment, the text view window, wherein the received text content “Europe” is converted into group tag information, and the received text content “United Kingdom” is converted into sub-tag information. Accordingly, the sub-tag information is displayed in a floating manner on the sub-tag overlay layer superimposed on the collected sub-album set and/or on the unit tag overlay layer superimposed on the selected unit image. The group tag information is displayed in a floating manner on the sub-tag overlay layer superimposed on the collected sub-album set and/or on the group tag overlay layer superimposed on the main album set and/or on the unit tag overlay layer superimposed on the selected unit image.

In summary, the disclosure embodiment aims to provide the user with an efficient and intuitive way to add tags to images in an album, thereby facilitating retrieval and browsing. Through a series of predetermined interactive actions, the user can add customized tags to each image. These tags are stored in a database and can be displayed in a floating manner on the images, allowing them to be disclosureed clearly and intuitively. The user can easily achieve personalized classification and tagging of images according to individual needs, thereby significantly improving management efficiency.

In the disclosure embodiment, when it is necessary to modify or delete any text content among the unit tag information, group tag information, or sub-tag information, the user may correspondingly modify or delete the relevant text content in the text view window, and the modification will be synchronized accordingly.

The foregoing embodiments are merely preferred embodiments of the disclosure discussed herein and are not intended to limit the disclosure discussed herein in any way. Any person skilled in the art may make various modifications, refinements, or adjustments to the disclosed technical solutions of the disclosure discussed herein without departing from the scope of the technical concept of the disclosure discussed herein, and such modifications shall fall within the scope of equivalent embodiments of the disclosure discussed herein. Therefore, all equivalent variations made based on the spirit and scope of the disclosure discussed herein shall be encompassed within the protection scope of the disclosure discussed herein.

It must be noted that as used herein and in the appended claims, the singular forms “a”, “an”, and “the” include their plural equivalents, unless the context clearly dictates otherwise.

1. A photo album image tagging method, comprising:
selecting at least one unit image in a thumbnail window of an album, or selecting a single unit image displayed in a detailed viewing window of the album;
receiving an addition instruction to add tag information to the selected unit image;
displaying a text view window to input text content;
receiving, in the text view window, at least one piece of text content regarding a tag; and
converting the text content of the tag into unit tag information, and displaying the unit tag information in a floating manner on a unit tag overlay layer superimposed on the selected unit image.

2. The photo album image tagging method according to claim 1, further comprising:
receiving, in the text view window, at least one piece of text content regarding a main group; and
based on the text content of the main group, collecting and folding the selected unit images to form an orderly arranged main album set, and converting the text content of the main group into group tag information, such that the group tag information is displayed in a floating manner on a group tag overlay layer superimposed on the collected main album set and/or on a unit tag overlay layer superimposed on the selected unit image.

3. The photo album image tagging method according to claim 2, further comprising:
receiving, in the text view window, text content regarding a main group and a sub-group; and
based on the text content of the sub-group, collecting the selected unit images to form an orderly arranged sub-album set, and forming the sub-album set as a new main album set or collecting it into an existing main album set according to the text content of the main group,
whereby the text content of the sub-group is converted into sub-tag information, which is displayed in a floating manner on a sub-tag overlay layer superimposed on the collected sub-album set and/or on a unit tag overlay layer superimposed on the selected unit image,
and the text content of the main group is converted into group tag information, which is displayed in a floating manner on the sub-tag overlay layer superimposed on the collected sub-album set.

4. The photo album image tagging method according to claim 1, wherein, when at least one unit image in the thumbnail window of the album is selected, the addition instruction comprises a predetermined interactive action, whereby the text view window is displayed based on the interactive action.

5. The photo album image tagging method according to claim 1, wherein, when a single unit image displayed in the detailed viewing window of the album is selected, the addition instruction comprises selecting an “Add” menu item in the detailed viewing window, whereby the text view window is displayed based on the selection of the “Add” menu item.

6. The photo album image tagging method according to claim 1, wherein the text view window is provided with at least one tag text box to input text content regarding a tag.

7. The photo album image tagging method according to claim 3, wherein the text view window is provided with at least one tag text box to input text content regarding the main group and the sub-group.
